(19) United States
(12) Patent Application Publication
(10) Pub. No.: US 2012/0100231 A1
(43) Pub. Date: Apr. 26, 2012

(54) Antimicrobial Compositions And Methods Of Making And Using The Same

(76) Inventors: Marc D. Perla, Atlanta, GA (US); Eric V. Salo, Atlanta, GA (US); Eric H. Richter, Atlanta, GA (US)

(21) Appl. No.: 13/380,560

(22) PCT Filed: Jun. 23, 2010
(86) PCT No.: PCT/US2010/039714

§ 371 Date: Dec. 23, 2011

Related U.S. Application Data
(63) Continuation-in-part of application No. 12/490,214, filed on Jun. 23, 2009.

(51) Int. Cl. A01N 65/36; C09D 5/14; A01P 3/00; A01N 43/16; A01P 1/00

(52) U.S. Cl. 424/736; 514/54; 514/25; 106/15.05

(57) ABSTRACT

Antimicrobial (e.g., moldicide, fungicide, bacteriacide, and virucide) compositions are disclosed. Methods of making and using antimicrobial (e.g., moldicide, fungicide, bacteriacide, and virucide) compositions are also disclosed.

This application is being filed as a PCT International Patent Application claiming priority to U.S. Utility patent application Ser. No. 12/490,214, filed on 23 Jun. 2009 and entitled “ANTIMICROBIAL COMPOSITIONS AND METHODS OF MAKING AND USING THE SAME.”

### FIELD OF THE INVENTION

The present invention relates generally to antimicrobial (e.g., moldicide, fungicide, bacteriacide, and virucide (i.e., antiviral)) compositions. The present invention further relates to methods of making and using antimicrobial compositions.

### BACKGROUND OF THE INVENTION

Many commercially available antimicrobial compositions exist. However, known commercially available antimicrobial compositions suffer from one or more shortcomings. For example, many commercially available antimicrobial compositions typically contain one or more composition components that are environmentally unfriendly. Such environmentally unfriendly components include, but are not limited to, phenols, quaternary ammonium compounds, iodine, sodium hypochlorite, and volatile organic compounds (VOCs).

In addition to containing one or more environmentally unfriendly components, many commercially available antimicrobial compositions contain one or more unsafe components or the overall composition is unsafe due to health concerns (e.g., contains one or more carcinogens; contains one or more components that are harmful to skin or eyes; contains one or more components that are harmful if inhaled or ingested, etc.) or other concerns (e.g., highly flammable, high or low pH, etc.). Many commercially available antimicrobial compositions are sold with one or more “signal” words, e.g., danger, poison, warning, caution, which indicate that the commercially available antimicrobial composition contains one or more potentially harmful components and should be used with caution. Additionally, the EPA regulates that these hazardous chemicals should not be released into groundwater and waterways. Biodegradability is also an issue with many of these conventionally used hazardous chemicals, as they can become even more hazardous as they break down, and as a consequence, cause water contamination and disruption of ecosystems (e.g. fisheries, estuaries, etc.).

Moreover, many commercially available antimicrobial compositions possess one of more of the above-mentioned shortcomings, and are relatively ineffective at providing antimicrobial and/or cleaning properties. For example, many commercially available antimicrobial compositions do not provide a desired degree of protection against a broad range of molds, fungi, bacteria, and/or viruses. Further, many commercially available antimicrobial compositions that may have previously provided some desired degree of protection against a particular mold, fungi, bacteria, and/or virus may have lost their potential to control and/or eradicate a given pathogen (e.g., a fungal pathogen) due to developed resistance of the given pathogen to currently used commercially available antimicrobial compositions (e.g., fungicides). For this reason there is an ongoing necessity for the development of innovative products that eradicate pathogens in a unique way.

There is a need in the art for effective, affordable antimicrobial compositions that are safe, and more environmentally friendly.

### SUMMARY OF THE INVENTION

The present invention is directed to antimicrobial (e.g., moldicide, fungicide, bacteriacide, and virucide (or antiviral)) compositions. The antimicrobial compositions comprise a combination of ingredients resulting in antimicrobial compositions having exceptional mold inhibition, fungi inhibition, bacteria, and/or virus/viral inhibition properties, wherein the antimicrobial compositions are free of unsafe, environmentally unfriendly materials typically found in conventional antimicrobial (e.g., moldicide, fungicide, bacteriacide, and virucide (or antiviral)) compositions.

The antimicrobial (e.g., moldicide, fungicide, bacteriacide, and virucide (or antiviral)) compositions of the present invention provide a sustainable formula that is effective as a safe, environmentally-friendly antimicrobial. The antimicrobial composition (e.g., fungicide, bacteriacide and virucide (e.g. anti-viral) results in exceptional fungi/bacteria inhibition, yet is free of material typically found in conventional antimicrobial compositions (i.e., those products containing chlorine, ammonia, and any of the other toxic compounds as noted above). Many of the antimicrobial compositions of the present invention are 100% organic, contain no known volatile organic compounds (VOCs), and contain ingredients which are GRAS (Generally Recognized as Safe) by the FDA.

The antimicrobial (e.g., moldicide, fungicide, bacteriacide, and virucide (or antiviral)) compositions of the present invention work to destroy mold/fungi/bacteria/viruses in a way that is completely safe and effective, as exemplified by two known mechanisms involved in the elimination of naturally-occurring single celled organisms (i.e., bacteria and certain fungi). The first is a well-documented method of cell wall disruption by penetration of hydrophobic tails of one or more ingredients of a given antimicrobial compositions of the present invention into the cell walls of living single celled organisms, leading to homeostasis. The second method, although not well understood, demonstrates changes in the inter-cellular pH, permeability and physical chemical paths leading to stunted growth and/or cell death of the living single celled organism. The combination of these two methods delivers a one-two punch in terms of preventing bacterial and fungal growth by using one or more naturally-occurring raw materials in the disclosed antimicrobial compositions. Further, it has been discovered that the antimicrobial properties of the naturally-occurring raw materials utilized in the disclosed antimicrobial compositions (e.g., the active ingredient in the form of at least one citrus extract complex compound) may be further enhanced when combined with other ingredients so as to form the disclosed antimicrobial compositions.

Accordingly, the present invention is directed to antimicrobial (e.g., moldicide, fungicide, bacteriacide, and virucide (or antiviral)) compositions. In one exemplary embodiment of the present invention, the antimicrobial compositions comprise a mixture of water; at least one citrus extract complex compound; and at least one component selected from a preservative and a surfactant; wherein the antimicrobial composition is a uniform mixture without phase separation of components into a liquid phase and a solid phase. In some embodiments, the antimicrobial compositions comprise a preservative, but not a surfactant. In other embodiments, the antimicrobial compositions comprise a surfactant, but not a preservative. In further embodiments, the antimicrobial compositions comprise both a preservative and a surfactant. In all embodiments, desirably, the at least one citrus extract complex compound comprises a citrus extract that does not include grapefruit and is not derived from grapefruit.

Any of the antimicrobial compositions of the present invention may further comprise (or consist essentially of, or consist of) a number of additional components in order to provide a particular composition property (e.g., additional anti-fungal properties, additional anti-bacterial properties, additional antiviral properties, disinfecting properties, cleaning properties, product stability, etc.) to a given antimicrobial composition. Suitable additional components include, but are not limited to, an optional complexing agent; an optional amount of ethanol; an optional amount of glycerin; an optional buffer system; an optional inhibitor; an optional dispersing agent; an optional amount of potassium carbonate; one or more optional thickening agents (also referred to herein as a binding/coating/thickening agent); and any combination thereof.

In a further exemplary embodiment of the present invention, the antimicrobial composition of the present invention comprises (or consists essentially of, or consists of) a mixture of water; at least one citrus extract complex compound, wherein the at least one citrus extract complex compound comprises (or consists essentially of, or consists of) (i) citrus medica limonum extract, (ii) a complex compound comprising (or consisting essentially of, or consisting of) ascorbic acid, citric acid, citric pectin, and citrus bioflavonoid, (iii) a complex compound comprising (or consisting essentially of, or consisting of) one or more limonoid glucosides and one or more bioflavonoids, or (iv) any combination of (i) to (iii); an optional amount of at least one preservative (e.g., potassium sorbate, potassium benzoate, sodium benzoate, or a combination thereof); an optional surfactant, the optional surfactant comprising (or consisting essentially of, or consisting of) a sodium lauryl sulfate, an alkyl polyglucopon, an alcohol ethoxylate and ethoxylated quaternary amine surfactant, or a combination thereof; an optional complexing agent, the optional complexing agent comprising (or consisting essentially of, or consisting of) tetrasodium iminodisuccinate; an optional amount of ethanol; an optional amount of glycerin; an optional buffer system, the optional buffer system comprising (or consisting essentially of, or consisting of) one or more of monosodium citrate, disodium citrate, trisodium citrate dihydrate, and/or citric acid; an optional inhibitor, the optional inhibitor comprising (or consisting essentially of, or consisting of) 2-phosphonobutane-1,2,4-tricarboxylic acid; an optional dispersing agent, the optional dispersing agent comprising (or consisting essentially of, or consisting of) sodium polyaspartate; an optional amount of potassium carbonate; and one or more optional thickening agents (also referred to herein as a binding/coating/thickening agent); wherein the antimicrobial composition is a uniform mixture without phase separation of components into a liquid phase and a solid phase.

The present invention is also directed to methods of making antimicrobial compositions. In one exemplary embodiment of the present invention, the method of making an antimicrobial composition comprises the steps of adding one or more composition components to water, and mixing the resulting antimicrobial composition.

The present invention is further directed to methods of using the disclosed antimicrobial compositions. In one exemplary embodiment of the present invention, the method of using the disclosed antimicrobial composition comprises the step of spraying, wiping, brushing, and/or dipping a surface of an object that needs cleaning and/or protecting. Suitable surfaces include, but are not limited to, hard surfaces, fibers, fabrics, building products, plants, etc. In other exemplary embodiments of the present invention, the method of using the disclosed antimicrobial composition comprises incorporating the disclosed antimicrobial composition into a product or product component as an ingredient or additive.

These and other features and advantages of the present invention will become apparent after a review of the following detailed description of the disclosed embodiments and the appended claims.

### DETAILED DESCRIPTION OF THE INVENTION

The present invention is directed to antimicrobial compositions. As used herein, the term “antimicrobial compositions” includes, but is not limited to, moldicide, fungicide, bacteriacide, and virucide (i.e., antiviral) compositions. The present invention is further directed to methods of making and using antimicrobial compositions.

The antimicrobial compositions of the present invention may comprise (or consist essentially of, or consist of) a number of components. A description of individual components and combinations of individual components is provided below.

### I. Antimicrobial Composition Components

The antimicrobial compositions of the present invention may comprise (or consist essentially of, or consist of) one or more of the following components.

A. Water

The antimicrobial compositions of the present invention comprise water. Soft or hard water may be used in the present invention, although soft water is more desirable. As used herein, the term “soft water” refers to water containing less than about 60 ppm of water hardness expressed as calcium carbonate content. As used herein, the term “hard water” refers to water containing more than about 60 ppm of water hardness expressed as calcium carbonate content, while “very hard water” refers to water containing more than about 180 ppm of water hardness expressed as calcium carbonate content. The antimicrobial compositions of the present invention may be formed using water available from any municipal water-treatment facility.

In one exemplary embodiment, the antimicrobial compositions of the present invention are prepared by filtering the water using any one or a combination of the following methods: ion exchange, adsorption, distillation, flocculation, membrane filtration, and reverse osmosis.

The antimicrobial compositions of the present invention typically comprise greater than about 84 weight percent (wt %) of water (desirably filtered water) (or any multiple of 0.05 wt % above 84 wt %) based on a total weight of a given antimicrobial composition. In exemplary embodiments, the antimicrobial compositions of the present invention comprise greater than about 90 wt % (or greater than about 91 wt %, or greater than about 93 wt %, or greater than about 95 wt %, or greater than about 96 wt %, or greater than about 98 wt %) of water (desirably filtered water) based on a total weight of a given antimicrobial composition. Desirably, the antimicrobial compositions of the present invention comprise from about 92 to about 95 wt % water (more desirably filtered water) based on a total weight of a given antimicrobial composition.

In some exemplary embodiments, the antimicrobial compositions of the present invention comprise concentrated antimicrobial compositions that may be diluted, upon use, with water. When present in a concentrate form, the antimicrobial concentrate compositions of the present invention typically comprise from about 65 wt % to about 85 wt % water (desirably filtered water) (or any multiple of 0.05 wt % between 65 wt % and 85 wt %) based on a total weight of a given antimicrobial concentrate composition. Desirably, the antimicrobial concentrate compositions of the present invention comprise from about 75 to about 85 wt % water (more desirably filtered water) based on a total weight of a given antimicrobial composition.

B. Citrus Extract Complex Compound

The antimicrobial compositions of the present invention comprise at least one citrus extract complex compound. As used herein, the term “citrus extract complex compound” is used to describe a composition comprising one or more components derived from a citrus fruit (e.g., the peel of a citrus fruit). Suitable citrus extract complex compounds include, but are not limited to, (i) citrus medica limonum extract (i.e., lemon extract that does not include grapefruit and is not derived from grapefruit), (ii) citrus limonum extract (i.e., lemon extract that does not include grapefruit and is not derived from grapefruit), (iii) a complex compound comprising ascorbic acid, citric acid, citric pectin, and citrus bioflavonoid, (iv) a complex compound comprising one or more limonoid glucosides and one or more bioflavonoids, or (v) any combination of (i) to (iv). Suitable citrus extract complex compounds include, but are not limited to, a citrus extract having CAS number 977038-62-2, which is a citrus medica limonum extract that does not include grapefruit and is not derived from grapefruit.

Each of the one or more citrus extract complex compounds may independently be present in a given antimicrobial composition in an amount of up to about 5.0 wt % (or any multiple of 0.05 wt % between 0 wt % and 5.0 wt %) based on a total weight of the antimicrobial composition. Typically, each of the one or more citrus extract complex compounds is independently present in a given antimicrobial composition in an amount ranging from about 0.1 to about 5.0 wt %, more desirably from about 0.1 to about 4.0 wt %, even more desirably from about 0.25 to about 2.5 wt % based on a total weight of the antimicrobial composition.

A number of commercially available citrus extract complex compounds may be used in the present invention. Suitable commercially available citrus extract complex compounds include, but are not limited to, BIOSECUR 160S® citrus extract complex compound, BIOSECUR 160S/162S® citrus extract complex compound, and BIOSECUR 162™ citrus extract complex compound, all of which are commercially available from BioSecur Lab, Inc. (Quebec, Canada).

C. Ethanol

The antimicrobial compositions of the present invention may further comprise ethanol, desirably derived from grain or cane. Suitable ethanol includes, but is not limited to, ethanol having a CAS number 64-17-5.

Ethanol may be present in a given antimicrobial composition in an amount of up to about 5.0 wt % (or any multiple of 0.05 wt % between 0 wt % and 5.0 wt %) based on a total weight of the antimicrobial composition. Typically, ethanol is present in a given antimicrobial composition in an amount ranging from about 1.0 to about 5.0 wt %, more desirably from about 2.0 to about 5.0 wt %, even more desirably from about 1.5 to about 4.0 wt % based on a total weight of the antimicrobial composition.

Ethanols suitable for use in the antimicrobial compositions of the present invention include, but are not limited to, ethanols commercially available under the trade designations EVERCLEAR™ and GOLDEN GRAIN™ Alcohols, all of which are commercially available from Luxco, Inc. (St. Louis, Mo.), and ethanols commercially available from Pharmco-AAPER, Inc. (Shelbyville, Ky.) with proofs of 190 or 200 (95-100 wt % ethanol content).

D. Preservatives

The antimicrobial compositions of the present invention may further comprise one or more preservatives. Suitable preservatives include, but are not limited to, potassium sorbate (e.g., FCC grade), sodium benzoate (e.g., USP grade), and potassium benzoate (e.g., USP grade), and any combination thereof. Suitable potassium sorbates include, but are not limited to, potassium sorbate having CAS number 24634-61-5. Suitable sodium benzoate may include a sodium benzoate having CAS number 532-32-1. Suitable potassium benzoate may include a potassium benzoate having CAS number 582-25-2.

When present, each of the one or more preservatives may be present in a given antimicrobial composition in an amount of up to about 8.0 wt % (or any multiple of 0.05 wt % between 0 wt % and 8.0 wt %) based on a total weight of the antimicrobial composition. Typically, when present, each of the one or more preservatives is present in a given antimicrobial composition in an amount ranging from about 0.1 to about 8.0 wt %, more desirably from about 0.5 to about 6.0 wt %, and even more desirably from about 0.5 to about 5.0 wt % based on a total weight of the antimicrobial composition.

Potassium sorbate suitable for use in the antimicrobial compositions of the present invention is commercially available from a number of sources including, but not limited to, Baddley Chemicals, Inc. (Baton Rouge, La.). Sodium benzoate suitable for use in the antimicrobial compositions of the present invention is commercially available from a number of sources including, but not limited to, Fisher Scientific, Inc. (Fair Lawn, N.J.). Potassium benzoate suitable for use in the antimicrobial compositions of the present invention is commercially available from a number of sources including, but not limited to, Fisher Scientific, Inc. (Fair Lawn, N.J.).

E. Potassium Carbonate

The antimicrobial compositions of the present invention may further comprise potassium carbonate (e.g., USP grade). Suitable potassium carbonate may include a potassium carbonate having CAS number 298-14-6.

When present, potassium carbonate may be present in the antimicrobial compositions in an amount of up to about 8.0 wt % (or any multiple of 0.05 wt % between 0 wt % and 8.0 wt %) based on a total weight of the antimicrobial composition. Typically, when present, potassium carbonate is present in the antimicrobial compositions in an amount ranging from about 0.1 to about 8.0 wt %, more desirably from about 0.5 to about 6.0 wt %, even more desirably from about 0.5 to about 5.0 wt % based on a total weight of the antimicrobial composition.

Potassium carbonate suitable for use in the antimicrobial compositions of the present invention is commercially available from a number of sources including, but not limited to, Fisher Scientific, Inc. (Fair Lawn, N.J.).

F. Surfactants

The antimicrobial compositions of the present invention may further comprise one or more surfactants, desirably plant derived surfactants. Suitable surfactants include, but are not limited to, sodium lauryl sulfates such as sodium lauryl sulfates having a CAS number 151-21-3; alkyl polyglucopons such as alkyl polyglucopon having CAS number 68515-73-1, alkyl polyglucopons having CAS number 110615-47-9, or any combination thereof; alcohol ethoxylates such as alcohol ethoxylates having CAS number 68991-48-0; ethoxylated quaternary amines such as ethoxylated quaternary amines having CAS number 61791-10-4; and any combination of a sodium lauryl sulfate, an alkyl polyglucopon, an alcohol ethoxylate, and an ethoxylated quaternary amine.

In one exemplary embodiment, the antimicrobial compositions of the present invention comprise a sodium lauryl sulfate. In another exemplary embodiment, the antimicrobial compositions of the present invention comprise an alkyl polyglucopon. In yet another exemplary embodiment, the antimicrobial compositions of the present invention comprise a sodium lauryl sulfate and an alkyl polyglucopon. In yet another exemplary embodiment, the antimicrobial compositions of the present invention comprise an alcohol ethoxylate in combination with an ethoxylated quaternary amine.

When present, each surfactant may be independently present in a given antimicrobial composition in an amount of up to about 10.0 wt % (or any multiple of 0.05 wt % between 0 wt % and 10.0 wt %) based on a total weight of the antimicrobial composition. Typically, when present, each surfactant is independently present in a given antimicrobial composition in an amount ranging from about 0.1 to about 9.0 wt %, more desirably from about 0.5 to about 9.0 wt %, and even more desirably from about 0.5 to about 8.0 wt % based on a total weight of the antimicrobial composition.

A number of commercially available surfactants may be used in the present invention. Suitable commercially available surfactants include, but are not limited to, sodium lauryl sulfates sold under the trade designations CALFOAM® SLS-30 and CALFOAM® SLS-95, both of which are commercially available from Pilot Chemical Co. (Red Bank, N.J.); alkyl glucosides sold under the trade designations GLUCOPON® 215UP, GLUCOPON® 225DK, GLUCOPON® 420UP, GLUCOPON® 425, GLUCOPON® 425N, GLUCOPON® 600UP, and GLUCOPON® 625UP, all of which are commercially available from Cognis Corporation (Cincinnati, Ohio); Videt Q-3, and Videt NQ-3, commercially available from Vitech International, Inc. (Janesville, Wis.).

G. Glycerin

The antimicrobial compositions of the present invention may further comprise glycerin (e.g., USP grade and/or Kosher grade) desirably derived from a vegetable source. Suitable glycerin may include, but is not limited to, glycerin having CAS number 56-81-5.

When present, glycerin is typically present in a given antimicrobial composition in an amount of up to about 10.0 wt % (or any multiple of 0.05 wt % between 0 wt % and 10.0 wt %) based on a total weight of the antimicrobial composition. Typically, when present, glycerin is present in a given antimicrobial composition in an amount ranging from about 0.2 to about 10.0 wt %, more desirably from about 0.25 to about 8.0 wt %, even more desirably from about 0.25 to about 6.0 wt % based on a total weight of the antimicrobial composition.

A number of commercially available glycerins may be used in the present invention. Suitable commercially available glycerins include, but are not limited to, EMERY® 917 commercially available from Cognis Oleochemicals, LLC (Cincinnati, Ohio). In addition, at least some of the above-described commercially available citrus extract complex compounds, such as BIOSECUR 160S® citrus extract complex compound, already contain vegetable glycerin.

H. Complexing Agents

The antimicrobial compositions of the present invention may further comprise one or more complexing agents. Suitable complexing agents include, but are not limited to, tetrasodium iminodisuccinate such as tetrasodium iminodisuccinate having CAS number 144538-83-0.

When present, each complexing agent may be independently present in a given antimicrobial composition in an amount of up to about 5.0 wt % (or any multiple of 0.05 wt % between 0 wt % and 5.0 wt %) based on a total weight of the antimicrobial composition. Typically, when present, each complexing agent is independently present in a given antimicrobial composition in an amount ranging from about 0.2 to about 5.0 wt %, more desirably from about 0.5 to about 4.0 wt %, even more desirably from about 1.0 to about 4.0 wt % based on a total weight of the antimicrobial composition.

A number of commercially available complexing agents may be used in the present invention. Suitable commercially available complexing agents include, but are not limited to, BAYPURE® CX100 commercially available from LANXESS Corporation (Pittsburgh, Pa.).

I. Dispersing Agents

The antimicrobial compositions of the present invention may comprise one or more dispersing agents. Suitable dispersing agents include, but are not limited to, sodium polyaspartate such as sodium polyaspartate having CAS number 181828-06-8.

When present, each dispersing agent is typically present in a given antimicrobial composition in an amount of up to about 4.0 wt % (or any multiple of 0.05 wt % between 0 wt % and 4.0 wt %) based on a total weight of the antimicrobial composition. Typically, when present, each dispersing agent is independently present in a given antimicrobial composition in an amount ranging from about 0.5 to about 4.0 wt %, and more desirably from about 0.5 to about 3.0 wt % based on a total weight of the antimicrobial composition.

A number of commercially available dispersing agents may be used in the present invention. Suitable commercially available dispersing agents include, but are not limited to, BAYPURE® DS100 commercially available from LANXESS Corporation (Pittsburgh, Pa.).

J. Buffer Systems

The antimicrobial compositions of the present invention may further comprise one or more buffer systems. Suitable buffer systems include, but are not limited to, buffer systems comprising one or more of the following components: monosodium citrate (CAS 18996-35-5), disodium citrate (CAS 6132-05-4), trisodium citrate dihydrate (CAS 6132-04-3), and citric acid (CAS number 77-92-9). One exemplary buffering system comprises about 18.5 parts (by weight) trisodium citrate dihydrate to about 1 part citric acid.

When present, a given buffer system may be present in a given antimicrobial composition in an amount of up to about 6.5 wt % (or any multiple of 0.05 wt % between 0 wt % and 6.5 wt %) based on a total weight of the antimicrobial composition. Typically, when present, the buffer system is present in a given antimicrobial composition in an amount ranging from about 0.25 to about 6.5 wt %, more desirably from about 0.25 to about 4.8 wt %, and even more desirably from about 0.25 to about 4.2 wt % based on a total weight of the antimicrobial composition.

A number of commercially available buffer system components may be used in the present invention. Suitable commercially available buffer system components include, but are not limited to, monosodium citrate USP/FCC Grade, disodium citrate USP/FCC Grade, trisodium citrate dihydrate USP/FCC Grade, and citric acid USP/FCC Grade, all of which are commercially available from DuPont Tate & Lyle BioProducts (Wilmington, Del.).

K. Inhibitors

The antimicrobial compositions of the present invention may further comprise one or more inhibitors. Suitable inhibitors include, but are not limited to, 2-phosphonobutane-1,2,4-tricarboxylic acid such as 2-phosphonobutane-1,2,4-tricarboxylic acid having CAS number 37971-36-1.

When present, each inhibitor is typically present in a given composition in an amount of up to about 1.0 wt % (or any multiple of 0.05 wt % between 0 wt % and 1.0 wt %) based on a total weight of the antimicrobial composition. Typically, when present, each inhibitor is present independently in a given antimicrobial composition in an amount ranging from greater than 0 to about 1.0 wt %, more desirably from about 0.1 to about 1.0 wt %, and even more desirably from about 0.1 to about 0.8 wt % based on a total weight of the antimicrobial composition.

A number of commercially available inhibitors may be used in the present invention. Suitable commercially available inhibitors include, but are not limited to, BAYHIBIT™ AM commercially available from LANXESS Corporation (Pittsburgh, Pa.).

L. Binding/Coating/Thickening Agents

The antimicrobial compositions of the present invention may further comprise one or more binding/coating/thickening agents (hereinafter referred to as a “thickening agent”). Suitable thickening agents include, but are not limited to, acrylic-styrene copolymer such as acrylic-styrene copolymer having CAS number 25085-34-1; a fluorinated, carboxylated acrylic copolymer; hydroxyethylcellulose such as hydroxyethylcellulose having CAS number 9004-62-0; vinyl chloride/vinyl acetate/maleic acid terpolymer such as vinyl chloride/vinyl acetate/maleic acid terpolymer having CAS number 9005-09-8; and a crosslinked acrylic acid copolymer such as crosslinked acrylic acid copolymer having CAS number 9003-01-4.

When present, each thickening agent is typically present in a given antimicrobial composition in an amount of up to about 8.0 wt % (or any multiple of 0.05 wt % between 0 wt % and 8.0 wt %) based on a total weight of the antimicrobial composition. Typically, when present, each thickening agent is independently present in a given antimicrobial composition in an amount ranging from about 0.1 to about 8.0 wt %, and more desirably from about 0.1 to about 7.0 wt % based on a total weight of the antimicrobial composition.

A number of commercially available thickening agents may be used in the present invention. Suitable commercially available thickening agents include, but are not limited to, SYNTRAN™ 1076, SYNTRAN™ 1671, MEGATRAN™ 220, and MEGATRAN™ 240 thickening agents commercially available from Interpolymer Corporation (Canton, Mass.); NATROSOL™ thickening agents commercially available from Hercules Incorporated (Wilmington, Del.); VINNOL™ thickening agents commercially available from Wacker Chemical Corporation (Adrian, Mich.); and CARBOPOL™ thickening agents commercially available from Noveon (Cleveland, Ohio).

### II. Methods of Making Antimicrobial Compositions

The present invention is further directed to methods of making the above-described antimicrobial compositions. In one exemplary embodiment of the present invention, the method of making a given antimicrobial composition comprises the steps of adding one or more of the above-described composition components to water, and mixing the resulting composition. In some exemplary embodiments, the method of making a given antimicrobial composition comprises the steps of adding one or more of the above-described composition components to water, and mixing the resulting composition so that the resulting composition consists essentially of water and one or more of the above-described composition components. In other exemplary embodiments, the method of making a given antimicrobial composition comprises the steps of adding one or more of the above-described composition components to water, and mixing the resulting composition so that the resulting composition consists of water and one or more of the above-described composition components.

Methods of making a given antimicrobial composition may further comprise one or more additional method steps including, but not limited to, weighing one or more composition components prior to adding the composition component to water, blending, packaging the antimicrobial composition in a container (e.g., a non-pressurized spray bottle, a bulk plastic container, etc.), and offering for sale the antimicrobial composition.

### III. Methods of Using Antimicrobial Compositions

The present invention is further directed to methods of using the above-described antimicrobial compositions. In one exemplary embodiment of the present invention, the method of using an antimicrobial composition comprises the step of spraying, wiping, brushing, and/or dipping a surface of an object that needs cleaning and/or protecting with an antimicrobial composition of the present invention.

In some exemplary embodiments of the present invention, the method of using an antimicrobial composition comprises the step of spraying and wiping kitchen countertops and floors for surface disinfection (e.g., removal and/or prevention of Bacillus cereus, Staphylococcus aureus, Stenotrophomonas maltophilia, and/or Serattia). In other exemplary embodiments of the present invention, the method of using an antimicrobial composition comprises the step of spraying and washing fruits, vegetables and plant seeds for disinfection (e.g., removal and/or prevention of Bacillus cereus, Staphylococcus aureus, Stenotrophomonas maltophilia, and/or Serattia). In other exemplary embodiments of the present invention, the method of using an antimicrobial composition comprises the step of wetting ceiling tile, a wallboard surface, and/or a raw wood surface with an antimicrobial composition of the present invention, and allowing the ceiling tile, a wallboard surface, and/or a raw wood surface to dry so as to form a protective coating on the ceiling tile, a wallboard surface, and/or a raw wood surface to prevent mold and/or mildew (e.g., removal and/or prevention of Candida albicans, mucor racemosus, Aspergillums' niger). In yet other exemplary embodiments of the present invention, the method of using an antimicrobial composition comprises the step of brushing tile, grout, brick, and/or stone with an antimicrobial composition of the present invention to remove and prevent mold (e.g., removal and/or prevention of Candida albicans, mucor racemosus, Aspergillums niger).

In yet other exemplary embodiments of the present invention, the method of using an antimicrobial composition may comprise the step of spraying (or otherwise applying) the antimicrobial composition onto crops, other plants, the exterior of buildings, and the exterior of other structures. This exemplary method is particularly useful when a binding agent or thickener is present in the antimicrobial composition.

In other exemplary embodiments of the present invention, the method of using an antimicrobial/antiviral composition of the present invention comprises the step of adding the antimicrobial/antiviral composition, as an ingredient or an additive, to the composition of other products. Other processes and products that may utilize the antimicrobial/antiviral composition of the present invention as an ingredient or an additive include, but are not limited to, pulp and paper, carpet fiber fabrication, yarn fabrication, substrates, filter media, bio-film control chemicals, chemical compounds, adhesives, sealants, caulking, grout, paints, coatings, cosmetics, cleaning products, soaps, rubber, films, medications, skin care and skin treatments, lotions, oral care and treatments, toothpastes, mouth washes, etc.

As discussed above, the antimicrobial/antiviral composition of the present invention may be used as a coating, or as an ingredient or an additive in a coating, for coating various substrates and/or surfaces. Suitable substrates and surfaces include, but are not limited to, metals, plastics, concrete, wood, and porous, non-porous, fibrous, and/or non-fibrous substrates. The antimicrobial/antiviral composition of the present invention thereby add value to the coated product (or product having the antimicrobial/antiviral composition incorporated therein) with a lasting antimicrobial/antiviral residual effect. Other products that may be coated include, but are not limited to, filtration devices, water filters, air filters, membranes, appliances, food preparation surfaces and devices, wall coverings, toys, countertops, roofing tiles, siding, building materials, floorings, carpeting, wipes, towelettes, towels, fabrics, textiles, apparel, shoes, medical devices, healthcare products, healthcare devices, veterinary products, veterinary devices, wound dressing pads, bandages, electronic devices, etc.

It has been discovered that, in some embodiments, the antimicrobial/antiviral compositions of the present invention may be used to control and eradicate fungal pathogens that are resistant to currently used fungicides (i.e., known, currently available antimicrobial/antiviral compositions).

Further, it has been discovered that the antimicrobial/antiviral compositions of the present invention provide synergistic antimicrobial/antiviral properties when compared to compositions comprising solely water and at least one citrus extract complex compound (e.g., BIOSECUR 160S® citrus extract complex compound, BIOSECUR 160S/162S® citrus extract complex compound, or BIOSECUR 162™ citrus extract complex compound). The synergistic antimicrobial/antiviral properties may include, but are not limited to, better antimicrobial/antiviral protection (i.e., resistance of growth) against one or more specific molds, fungi, bacteria, and/or virus; better antimicrobial/antiviral protection (i.e., resistance of growth) against a broader range of molds, fungi, bacteria, and/or virus; or both.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

### Preparation of Antimicrobial Compositions

Exemplary antimicrobial compositions of the present invention were prepared using components shown in Table 1 below.

TABLE 1
Antimicrobial Composition Components Used in Example

| | | Component |
|---|---|---|
| Component | Source | Class |
| filtered water | municipal | solvent |
| BIOSECUR 160S ® | BioSecur Lab, Inc. | citrus extract |
| | (Quebec, Canada) | complex |
| | | compound |
| ethanol | Luxco, Inc. | solvent |
| | (St. Louis, MO) | |
| potassium sorbate | Baddley Chemicals, Inc. | potassium |
| | (Baton Rouge, LA) | sorbate |
| CALFOAM ® SLS-30 | Pilot Chemical Co. | surfactant |
| | (Red Bank, NJ | |
| GLUCOPON ® 600UP | Cognis Corporation | surfactant |
| | (Cincinnati, OH) | |
| EMERY ® 917 | Cognis Oleochemicals, | glycerin |
| | LLC (Cincinnati, OH) | |
| BAYPURE ® CX100 | LANXESS Corporation | complexing |
| (tetrasodium | (Pittsburgh, PA) | agent |
| iminodisuccinate) | | |
| BAYPURE ® DS100 | LANXESS Corporation | dispersing |
| | (Pittsburgh, PA) | agent |
| trisodium citrate | Dupont Tate & Lyle Bio | buffer |
| dihydrate USP/FCC | Products (Wilmington, DE | system |
| Grade | | component |
| citric acid USP/FCC | Dupont Tate & Lyle Bio | buffer |
| Grade | Products (Wilmington, DE | system |
| | | component |
| BAYHIBIT ™ AM | LANXESS Corporation | inhibitor |
| (2-phosphonobutane- | (Pittsburgh, PA) | |
| 1,2,4-tricarboxylic acid) | | |
| sodium benzoate | Fisher Scientific | preservative |
| | (Fair Lawn, NJ) | |
| potassium benzoate | Fisher Scientific | preservative |
| | (Fair Lawn, NJ) | |
| potassium carbonate | Fisher Scientific | potassium |
| | (Fair Lawn, NJ) | carbonate |
| VIDET ™ NQ-3 | Vitech International | surfactant |
| | (Janesville, WI) | |
| GLUCOPON ® 420UP | Cognis Corporation | surfactant |
| | (Cincinnati, OH) | |
| GLUCOPON ® 425N | Cognis Corporation | surfactant |
| | (Cincinnati, OH) | |
| monosodium citrate | Dupont Tate & Lyle Bio | buffer |
| | Products (Wilmington, DE) | system |
| | | component |
| disodium citrate | Dupont Tate & Lyle Bio | buffer |
| | Products (Wilmington, DE) | system |
| | | component |
| NATROSOL ™ | Hercules Inc. | binding/ |
| | (Wilmington, DE) | coating/ |
| | | thickening |
| | | agent |
| VINNOL ™ | Wacker Chemical Corp. | binding/ |
| | (Adrian, MI) | coating/ |
| | | thickening |
| | | agent |
| CARBOPOL ™ | Noveon (Cleveland, OH) | binding/ |
| | | coating/ |
| | | thickening |
| | | agent |
| SYNTRAN ™ 1076 | Interpolymer Corp. | binding/ |
| | (Canton, MA) | coating/ |
| | | thickening |
| | | agent |
| SYNTRAN ™ 1671 | Interpolymer Corp. | binding/ |
| | (Canton, MA) | coating/ |
| | | thickening |
| | | agent |
| MEGATRAN ™ 220 | Interpolymer Corp. | binding/ |
| | (Canton, MA) | coating/ |
| | | thickening |
| | | agent |
| MEGATRAN ™ 240 | Interpolymer Corp. | binding/ |
| | (Canton, MA) | coating/ |
| | | thickening |
| | | agent |

In the preparation of each antimicrobial composition, one or more composition components from Table 1 were added to water while mixing. Resulting antimicrobial compositions are provided in Tables 2-6 below.

TABLE 2
Sample Antimicrobial Compositions

| | Sample | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| Component | weight percent (wt %) | | | | | | | | | | | | | | |
| filtered water | 92.85 | 93.80 | 93.75 | 97.40 | 96.45 | 91.50 | 93.75 | 92.65 | 91.50 | 90.90 | 93.70 | 92.95 | 91.00 | 89.00 | 85.40 |
| BIOSECUR 160S ® | 0.15 | 0.20 | 0.25 | 0.10 | 0.30 | 1.0 | 0.25 | 0.35 | 0.50 | 2.00 | 0.30 | 0.25 | 0.10 | 0.20 | 0.40 |
| ethanol | 5.0 | 3.0 | 2.0 | 1.0 | 0.5 | 2.5 | 2.0 | 3.0 | 4.0 | 2.0 | 1.5 | 1.0 | 3.0 | 4.0 | 5.0 |
| potassium sorbate | 2.0 | 3.0 | 4.0 | 1.0 | 2.0 | 3.5 | 3.0 | 2.0 | 1.0 | 0.3 | 0.5 | 0.1 | 0.5 | 1.0 | 1.5 |
| CALFOAM ® | | | | | | | | | | | | | 0.2 | 0.5 | 1.0 |
| SLS-30 | | | | | | | | | | | | | | | |
| GLUCOPON ® | | | | 0.50 | 0.75 | 1.5 | | | | | 0.1 | | | | |
| 600UP | | | | | | | | | | | | | | | |
| EMERY ® 917 | | | | | | | | | | 0.5 | | 2.0 | 1.0 | 0.5 | 0.2 |
| BAYPURE ® | | | | | | | 1.0 | 2.0 | 3.0 | | | | | | |
| CX100 | | | | | | | | | | | | | | | |
| trisodium citrate | | | | | | | | | | 4.08 | 3.70 | 3.51 | 3.98 | 4.55 | 6.17 |
| dihydrate | | | | | | | | | | | | | | | |
| USP/FCC Grade | | | | | | | | | | | | | | | |
| citric acid | | | | | | | | | | 0.22 | 0.20 | 0.19 | 0.22 | 0.25 | 0.33 |
| USP/FCC Grade | | | | | | | | | | | | | | | |

TABLE 3
Sample Antimicrobial Compositions

| | Sample | | | | | | | | | | | | | | |
|---|---|---|---|---|---|---|---|---|---|---|---|---|---|---|---|
| | 16 | 17 | 18 | 19 | 20 | 21 | 22 | 23 | 24 | 25 | 26 | 27 | 28 | 29 | 30 |
| Component | weight percent (wt %) | | | | | | | | | | | | | | |
| filtered water | 91.50 | 94.25 | 94.20 | 91.00 | 94.50 | 97.00 | 96.0 | 93.0 | 83.0 | 92.5 | 78.5 | 95.0 | 93.5 | 98.75 | 85.0 |
| BIOSECUR 160S ® | 1.0 | 0.5 | 2.5 | 1.0 | 0.5 | 0.25 | 0.5 | 0.5 | 2.5 | 0.5 | 2.5 | 0.5 | 0.5 | 0.5 | 2.0 |
| ethanol | 4.0 | 3.0 | 2.0 | 3.0 | 2.0 | 1.0 | | | | | | 2.0 | 1.0 | | |
| GLUCOPON ® 600UP | 2.0 | 1.5 | 1.0 | 2.0 | 1.5 | 1.0 | | | | | | | | | |
| EMERY ® 917 | | | | 1.0 | 0.5 | 0.25 | | 2.0 | 5.0 | 2.0 | 4.0 | 1.0 | 2.0 | | 4.0 |
| BAYPURE ® CX100 | 1.0 | 0.5 | 0.2 | | | | | | | | | | | | 1.0 |
| BAYPURE ® DS100 | | | | 2.0 | 1.0 | 0.5 | | | | | | | | | 2.0 |
| BAYHIBIT ™ AM | 0.5 | 0.25 | 0.10 | | | | | | | | | | | | |
| GLUCOPON ® 425N | | | | | | | 1.5 | 2.0 | 4.0 | | | | | | |
| potassium sorbate | | | | | | | 2.0 | 2.5 | 3.5 | 2.0 | 4.0 | | | | |
| disodium citrate | | | | | | | | | 2.0 | 1.0 | | | | | |
| VIDET ™ NQ-3 | | | | | | | | | | 2.0 | 8.0 | | | | |
| trisodium citrate | | | | | | | | | | | 3.0 | | | | |
| dihydrate | | | | | | | | | | | | | | | |
| monosodium citrate | | | | | | | | | | | | 1.0 | 1.0 | 0.25 | 4.0 |
| sodium benzoate | | | | | | | | | | | | 0.5 | 2.0 | 0.5 | 2.0 |
| potassium benzoate | | | | | | | | | | | | | | | |

TABLE 4
Sample Antimicrobial Compositions

| | Sample | | | | | | | | | | | | | | |
|---|---|---|---|---|---|---|---|---|---|---|---|---|---|---|---|
| | 31 | 32 | 33 | 34 | 35 | 36 | 37 | 38 | 39 | 40 | 41 | 42 | 43 | 44 | 45 |
| Component | weight percent (wt %) | | | | | | | | | | | | | | |
| filtered water | 94.0 | 97.3 | 93.1 | 93.4 | 83.5 | 91.0 | 97.1 | 92.8 | 93.3 | 82.5 | 80.6 | 94.7 | 92.0 | 79.2 | 91.5 |
| BIOSECUR 160S ® | 2.0 | 0.7 | 0.5 | 0.6 | 2.5 | 1.0 | 0.7 | 0.5 | 0.6 | 2.5 | 1.0 | 0.5 | 0.5 | 2.5 | 0.5 |
| ethanol | | | 1.0 | 2.0 | 2.0 | | | 1.0 | 2.0 | 2.0 | | | | | |
| GLUCOPON ® 600UP | | | | | | | | | | | | | | | |
| BAYPURE ® CX100 | | | | | | | | | | | | 1.0 | 0.5 | 3.0 | 0.5 |
| BAYPURE ® DS100 | | | | | | | | | | | | | | | |
| GLUCOPON ® 425N | | | | | | | | | | | | 1.5 | 2.0 | 4.0 | |
| potassium sorbate | | | | | | | | | | | | 2.0 | 2.5 | 3.5 | 2.0 |
| EMERY ® 917 | | | 2.0 | | 4.0 | | | 2.0 | | 4.0 | | | 2.0 | 5.0 | 2.0 |
| disodium citrate | | | | | | | | | | | | | | 2.0 | 1.0 |
| VIDET ™ NQ-3 | | 2.0 | 1.9 | 2.0 | 8.0 | 5.0 | 2.0 | 1.9 | 2.0 | 8.0 | 5.0 | | | | 2.0 |
| trisodium citrate | | | | | | | | | | | | | | | |
| dihydrate | | | | | | | | | | | | | | | |
| monosodium citrate | 1.0 | | 1.0 | 1.0 | | | | 1.0 | 1.0 | | | | | | |
| sodium benzoate | | | 0.5 | | | | | 0.5 | | | | | | | |
| potassium benzoate | 3.0 | | | 1.0 | | | | | 1.0 | | | | | | |
| potassium carbonate | | | | | | 3.0 | | | | | 3.0 | | | | |
| NATROSOL ™ | | | | | | | 0.2 | 0.3 | 0.1 | 1.0 | 0.4 | 0.3 | 0.5 | 0.8 | 0.5 |

TABLE 5
Sample Antimicrobial Compositions

| | Sample | | | | | | | | | | | | | | |
|---|---|---|---|---|---|---|---|---|---|---|---|---|---|---|---|
| | 46 | 47 | 48 | 49 | 50 | 51 | 52 | 53 | 54 | 55 | 56 | 57 | 58 | 59 | 60 |
| Component | weight percent (wt %) | | | | | | | | | | | | | | |
| filtered water | 75.5 | 91.9 | 93.2 | 92.0 | 93.1 | 88.0 | 94.9 | 92.4 | 79.5 | 91.8 | 77.1 | 97.1 | 92.8 | 93.3 | 82.5 |
| BIOSECUR 160S ® | 2.5 | 0.5 | 0.5 | 2.5 | 0.5 | 2.0 | 0.5 | 0.5 | 2.5 | 0.5 | 2.5 | 0.7 | 0.5 | 0.6 | 2.5 |
| ethanol | | 1.0 | 1.0 | 1.0 | 1.0 | | | | | | | | 1.0 | 2.0 | 2.0 |
| GLUCOPON ® 420UP | | 1.0 | 1.0 | 1.0 | 1.9 | 5.0 | | | | | | | | | |
| BAYPURE ® CX100 | 1.0 | | | | | | 1.0 | 0.5 | 3.0 | 0.5 | 1.0 | | | | |
| CARBOPOL ™ | | | | | | | 0.1 | 0.1 | 0.5 | 0.2 | 0.4 | | | | |
| GLUCOPON ® 425N | | | | | | | 1.5 | 2.0 | 4.0 | | | | | | |
| potassium sorbate | 4.0 | 0.15 | 0.3 | 0.3 | | | 2.0 | 2.5 | 3.5 | 2.0 | 4.0 | | | | |
| EMERY ® 917 | 4.0 | 1.5 | 1.5 | 1.5 | 2.0 | 5.0 | | 2.0 | 5.0 | 2.0 | 4.0 | | 2.0 | | 4.0 |
| disodium citrate | | | 2.0 | | | | | | 2.0 | 1.0 | | | | | |
| VIDET ™ NQ-3 | 8.0 | | | | | | | | | 2.0 | 8.0 | 2.0 | 1.9 | 2.0 | 8.0 |
| trisodium citrate | 3.0 | 1.32 | | | | | | | | | 3.0 | | | | |
| dihydrate | | | | | | | | | | | | | | | |
| monosodium citrate | | | | | 1.0 | | | | | | | | 1.0 | 1.0 | |
| sodium benzoate | | | | | 0.5 | | | | | | | | 0.5 | | |
| potassium benzoate | | | | | | | | | | | | | | 1.0 | |
| potassium carbonate | | 2.63 | 0.5 | 3.7 | | | | | | | | | | | |
| NATROSOL ™ | 2.0 | | | | | | | | | | | | | | |
| VINNOL ™ | | | | | | | | | | | | 0.2 | 0.3 | 0.1 | 1.0 |

TABLE 6
Sample Antimicrobial Compositions

| | Sample | | | | | | | | | | | | |
|---|---|---|---|---|---|---|---|---|---|---|---|---|---|
| | 61 | 62 | 63 | 64 | 65 | 66 | 67 | 68 | 69 | 70 | 71 | 72 | 73 |
| Component | weight percent (wt %) | | | | | | | | | | | | |
| filtered water | 90.6 | 94.0 | 92.0 | 75.5 | 91.0 | 74.5 | 90.0 | 88.0 | 75.5 | 85.0 | 70.5 | 95.0 | 95.0 |
| BIOSECUR 160S ® | 1.0 | 0.5 | 0.5 | 2.5 | 0.5 | 2.5 | 0.5 | 0.5 | 2.5 | 0.5 | 2.5 | 0.25 | 0.5 |
| MEGATRAN ™ 220 | | 1.0 | | 4.0 | | 3.0 | | | | | | | |
| MEGATRAN ™ 240 | | | 0.5 | | 1.0 | | | | | | | | |
| BAYPURE ® CX100 | | 1.0 | 0.5 | 3.0 | 0.5 | 1.0 | 1.0 | 0.5 | 3.0 | 0.5 | 1.0 | | |
| CARBOPOL ™ | | | | | | | | | | | | | |
| GLUCOPON ® 425N | | 1.5 | 2.0 | 4.0 | | | 1.5 | 2.0 | 4.0 | | | | |
| potassium sorbate | | 2.0 | 2.5 | 3.5 | 2.0 | 4.0 | 2.0 | 2.5 | 3.5 | 2.0 | 4.0 | 3.75 | 3.5 |
| EMERY ® 917 | | | 2.0 | 5.0 | 2.0 | 4.0 | | 2.0 | 5.0 | 2.0 | 4.0 | | |
| disodium citrate | | | | 2.0 | 1.0 | | | | 2.0 | 1.0 | | | |
| VIDET ™ NQ-3 | 5.0 | | | | 2.0 | 8.0 | | | | 2.0 | 8.0 | 1.0 | 1.0 |
| trisodium citrate | | | | | | 3.0 | | | | | 3.0 | | |
| dihydrate | | | | | | | | | | | | | |
| SYNTRAN ™ 1076 | | | | | | | 5.0 | | 4.0 | | 7.0 | | |
| SYNTRAN ™ 1671 | | | | | | | | 4.5 | | 7.0 | | | |
| potassium benzoate | | | | | | | | | | | | | |
| potassium carbonate | 3.0 | | | | | | | | | | | | |
| NATROSOL ™ | | | | | | | | | | | | | |
| VINNOL ™ | 0.4 | | | | | | | | | | | | |

### Example 2

### Testing of Antimicrobial Compositions

Zone of inhibition studies were conducted to evaluate the antifungal activity of various antimicrobial compositions for Aspergillums niger. Aspergillums niger (ATCC #16404) was used as received and subsequently revived. Antifungal activity of each composition was evaluated using a disk diffusion method as disclosed in Singh J., Zaman M., Gupta, A. K., “Evaluation of microdilution and disk diffusion methods for antifungal susceptibility testing of dermatophytes”, Med. Mycol. 2007 Sep. 18; 1-8).

Briefly, glucose potato agar (GPA) plates were prepared using fresh potato for extraction of potato extract, glucose and agar granules. Reviving the lyophilized fungal was performed as instructed by ATCC. A well-grown 4-5 days fungal culture was used to prepare a fungal suspension in sterile filtered water. GPA plates were inoculated with a given suspension using a fresh sterile cotton swab for each plate. Three holes with 0.4 cm diameter were made in each plate. The holes were filled with 120 μl of each sample composition and incubated in a box containing water to produce required moisture at 26° C. for 4-5 days. The zones of inhibition were measured.

A zone of inhibition of 6-7 mm resulted for water containing 0.5 wt % of citrus extract complex compound (i.e., BIOSECUR 160S®). A zone of inhibition of 6-8 mm resulted for water containing 1.0 wt % of the citrus extract complex compound. A zone of inhibition of 9-10 mm resulted for water containing 4.0 wt % of the citrus extract complex compound.

Sample 72 from Example 1 resulted in a zone of inhibition of 42-43 mm. Sample 73 from Example 1 resulted in a zone of inhibition of 34-35 mm Each of Samples 72 and 73 showed a substantial increase in efficacy (i.e., approximately 8× more effective compared to the 4 wt % comparative sample).

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. An antimicrobial composition comprising a mixture of:
water;
at least one citrus extract complex compound, wherein said at least one citrus extract complex compound comprises a citrus extract that does not include grapefruit and is not derived from grapefruit; and
at least one component selected from a preservative and a surfactant;
said antimicrobial composition being a uniform mixture without phase separation of components into a liquid phase and a solid phase.

2. The antimicrobial composition of claim 1, wherein said at least one citrus extract complex compound comprises (i) a citrus medica limonum extract, (ii) a complex compound comprising ascorbic acid, citric acid, citric pectin, and citrus bioflavonoid, (iii) a complex compound comprising one or more limonoid glucosides and one or more bioflavonoids, or (iv) any combination of (i) to (iii).

3. The antimicrobial composition of claim 1, wherein said antimicrobial composition comprises a preservative selected from potassium sorbate, sodium benzoate, potassium benzoate, or a combination thereof.

4. The antimicrobial composition of claim 3, wherein said preservative comprises potassium sorbate.

5. The antimicrobial composition of claim 1, wherein said antimicrobial composition comprises a surfactant, said surfactant comprising a sodium lauryl sulfate, an alkyl polyglucopon, an alcohol ethoxylate, an ethoxylated quaternary amine, or a combination thereof.

6. The antimicrobial composition of claim 5, wherein said surfactant comprises an alcohol ethoxylate in combination with an ethoxylated quaternary amine.

7. The antimicrobial composition of claim 5, wherein said surfactant comprises an alkyl polyglucopon.

8. The antimicrobial composition of claim 1, wherein said antimicrobial composition further comprises a buffer system, said buffer system comprising at least one of monosodium citrate, disodium citrate, trisodium citrate dehydrate, and citric acid.

9. The antimicrobial composition of claim 1, wherein said antimicrobial composition further comprises ethanol.

10. The antimicrobial composition of claim 1, wherein said antimicrobial composition further comprises glycerin.

11. The antimicrobial composition of claim 1, wherein said antimicrobial composition further comprises a complexing agent, said complexing agent comprising tetrasodium iminodisuccinate.

12. The antimicrobial composition of claim 1, wherein said antimicrobial composition further comprises a binding or thickening agent, said binding or thickening agent comprising an acrylic-styrene copolymer; a fluorinated, carboxylated acrylic copolymer; hydroxyethylcellulose; vinyl chloride/vinyl acetate/maleic acid terpolymer; a crosslinked acrylic acid copolymer; or any combination thereof.

13. The antimicrobial composition of claim 1, wherein said antimicrobial composition further comprises a dispersing agent, said dispersing agent comprising sodium polyaspartate.

14. The antimicrobial composition of claim 1, wherein said antimicrobial composition further comprises an inhibitor, said inhibitor comprising 2-phosphonobutane-1,2,4-tricarboxylic acid.

15. The antimicrobial composition of claim 1, wherein said antimicrobial composition further comprises potassium carbonate.

16. The antimicrobial composition of claim 1, wherein said antimicrobial composition comprises:
at least about 65 wt % of said water;
from about 0.1 to about 5.0 wt % of said citrus extract complex compound;
when present, from greater than 0 to about 8.0 wt % of said preservative;
when present, from greater than 0 to about 10.0 wt % of said surfactant;
when present, from greater than 0 to about 6.5 wt % of said buffer system;
when present, from greater than 0 to about 5.0 wt % of said ethanol;
when present, from greater than 0 to about 10.0 wt % of said glycerin;
when present, from greater than 0 to about 5.0 wt % of said complexing agent;
when present, from greater than 0 to about 8.0 wt % of said binding or thickening agent;
when present, from greater than 0 to about 4.0 wt % of said dispersing agent;
when present, from greater than 0 to about 1.0 wt % of said inhibitor; and
when present, from greater than 0 to about 8.0 wt % of said potassium carbonate;
wherein all weight percentages are based on a total weight of said antimicrobial composition.

17. The antimicrobial composition of claim 1, wherein said antimicrobial composition consists essentially of (i) water, (ii) the at least one citrus extract complex compound, (iii) a preservative and (iv) a surfactant.

18. The antimicrobial composition of claim 1, wherein said antimicrobial composition consists solely of (i) water, (ii) the at least one citrus extract complex compound, (iii) a preservative and (iv) a surfactant.

19. A method of making the antimicrobial composition of claim 1, said method comprising combining (i) water, (ii) the at least one citrus extract complex compound, (iii) a preservative and (iv) a surfactant, and mixing.

20. A method of using the antimicrobial composition of claim 1, said method comprising applying the antimicrobial composition onto a surface of a product or incorporating the antimicrobial composition into a product or composition.

21. (canceled)
